(19) United States
(12) Patent Application Publication
(10) Pub. No.: US 2019/0245207 A1
(43) Pub. Date: Aug. 8, 2019

(54) ELECTROCHEMICAL DEVICE

(71) Applicant: Panasonic Intellectual Property Management Co., Ltd., Osaka (JP)

(72) Inventors: HIROKI HAYASHI, Kyoto (JP); SUSUMU NOMOTO, Kyoto (JP)

(21) Appl. No.: 16/341,945

(22) PCT Filed: Oct. 26, 2017
(86) PCT No.: PCT/JP2017/038617

§ 371 Date: Apr. 15, 2019

(30) Foreign Application Priority Data
Oct. 28, 2016 (JP) 2016-212210

(51) Int. Cl. H01M 4/60; H01M 10/0569; H01M 10/0525; H01M 10/0568; H01G 11/06; H01G 11/62; H01G 11/48; H01G 11/60; H01G 11/50; C08G 73/02

(52) U.S. Cl. CPC H01M 4/608; H01M 10/0569; H01M 10/0525; H01M 10/0568; H01G 11/06; H01M 2004/028; H01G 11/48; H01G 11/60; H01G 11/50; C08G 73/0266; H01M 2300/0037; H01G 11/62

(57) ABSTRACT

In an electrochemical device combining a positive electrode including a conductive polymer that is to be doped and dedoped with anions with a negative electrode including a negative electrode material that occludes and releases lithium ions, float characteristics in the electrochemical device can be maintained. The electrochemical device includes: a positive electrode including, as a positive electrode active material, a conductive polymer that is to be doped and dedoped with anions, a negative electrode including a negative electrode active material that occludes and releases lithium ions, and an electrolytic solution containing the anions and the lithium ions. 0<B/A<0.7 is satisfied, where A represents a total amount (mol) of monomer units that constitute the conductive polymer included in the positive electrode and B represents a total amount (mol) of the anions included in the electrochemical device.

### TECHNICAL FIELD

The present disclosure relates to an electrochemical device combining a positive electrode including, as a positive electrode active material, a conductive polymer that is to be doped and dedoped with anions with a negative electrode including a negative electrode active material that occludes and releases lithium ions.

### BACKGROUND

In recent years, electrochemical devices having intermediate property between a lithium ion secondary battery and an electric double layer capacitor attract attention. For example, use of a conductive polymer as a positive electrode active material is studied. Since such electrochemical devices including a conductive polymer as a positive electrode active material are charged and discharged by adsorption (doping) and desorption (dedoping) of anions. Hence, the positive electrode has small reaction resistance, and has higher output than a positive electrode of a general lithium ion secondary battery does. As conductive polymers, polyaniline, polypyrrole and the like are known (see PTL 1 and 2).

### CITATION LIST

### Patent Literature

PTL 1: Unexamined Japanese Patent Publication No. 1-146255

PTL 2: Unexamined Japanese Patent Publication No. 2014-35836

### SUMMARY

An electrochemical device is used, for example, as a backup power supply for supplying electric power to a device such as a PC or a server when electric power supply to the device is interrupted due to a power failure or the like. In normal conditions, a state in which a predetermined voltage is applied to the electrochemical device is maintained (the electrochemical device is subjected to float charge). In abnormal conditions such as a power failure, electric power is supplied from the electrochemical device to the device (the electrochemical device is discharged). When the electrochemical device is subjected to float charge for a long time, the positive electrode active material (conductive polymer) tends to deteriorate and the capacitance tends to decrease. Therefore, it is important to suppress the decrease in capacitance of the electrochemical device after the float charge (to maintain float characteristics of the electrochemical device).

A relation between the float characteristics and the balance between the amount of monomer units that constitute the conductive polymer in the positive electrode and the amount of anions included in the electrochemical device has not been sufficiently studied.

In view of the above, an aspect of the present disclosure relates to an electrochemical device including: a positive electrode including, as a positive electrode active material, a conductive polymer that is to be doped and dedoped with anions, a negative electrode including a negative electrode active material that occludes and releases lithium ions, and an electrolytic solution containing the anions and the lithium ions. 0<B/A<0.7 is satisfied, where A represents a total amount (mol) of monomer units that constitute the conductive polymer included in the positive electrode and B represents a total amount (mol) of the anions included in the electrochemical device.

According to the present disclosure, in an electrochemical device combining a positive electrode including, as a positive electrode active material, a conductive polymer that is to be doped and dedoped with anions with a negative electrode including a negative electrode active material that occludes and releases lithium ions, a decrease in capacitance after the float charge can be suppressed (float characteristics can be maintained).

### BRIEF DESCRIPTION OF DRAWINGS

FIG. 1 is a schematic cross-sectional view illustrating an electrochemical device according to an exemplary embodiment of the present disclosure.

FIG. 2 is a schematic view for illustrating a structure of the electrochemical device according to the exemplary embodiment.

FIG. 3 is a graph showing a relation between B/A and capacitance retention rate in electrochemical devices according to an exemplary embodiment of the present disclosure.

### DESCRIPTION OF EMBODIMENT

The present disclosure relates to an electrochemical device including: a positive electrode including, as a positive electrode active material, a conductive polymer that is to be doped and dedoped with anions as a positive electrode material, a negative electrode including a negative electrode active material that occludes and releases lithium ions, and an electrolytic solution containing the anions and the lithium ions. During charging, the anions in the electrolytic solution are doped into the conductive polymer, and the lithium ions in the electrolytic solution are occluded in the negative electrode material. During discharging, the anions are dedoped from the conductive polymer and move into the electrolytic solution, and the lithium ions are released from the negative electrode material and move into the electrolytic solution. In the present disclosure, there are cases where the conductive polymer exhibits almost no conductivity or no conductivity at all in a state where anions have been dedoped from the conductive polymer.

0<B/A<0.7 is satisfied,

where A represents A total amount (mol) of monomer units that constitute the conductive polymer included in the positive electrode and B represents a total amount (mol) of the anions included in the electrochemical device.

The value of B/A gets close to 0, as the total amount A of monomer units that constitute the conductive polymer included in the positive electrode become larger compared to the total amount B of anions included in the electrochemical device. The total amount B of anions included in the electrochemical device is required to be at least an amount that is necessary for obtaining a predetermined discharge capacitance.

When B/A is within the above-mentioned range, the float characteristics can be maintained. If B/A is 0.7 or more, a large amount of anions are included in the electrolytic solution, and the proportion of the conductive polymer that is doped with anions in the positive electrode during charging is large. Accordingly, the proportion of the conductive polymer deteriorated during long-term float charge is large, so that the float characteristics are deteriorated.

B/A is preferably 0.2 or more. In this case, during charging, the conductive polymer can be doped with an appropriate amount of anions from the electrolytic solution, and good discharge capacitance can be obtained. In addition, since a large amount of anions are included in the electrolytic solution and good ion conductivity is obtained, good discharge capacitance can be obtained.

0<C/A<0.7 is preferably satisfied,

where A represents a total amount (mol) of monomer units that constitute the conductive polymer included in the positive electrode and C represents an amount (mol) of anions that are doped into the conductive polymer included in the positive electrode in a charged state of the electrochemical device.

In this case, it is possible to reduce the proportion of the conductive polymer that is doped with anions in the positive electrode during charging to sufficiently reduce the proportion of the conductive polymer that is deteriorated during long-term float charge, so that the float characteristics can be further maintained. In the charged state of the electrochemical device, when most of the anions in the electrolytic solution are doped into the conductive polymer in the positive electrode and the electrolytic solution contains almost no anions, the value of C is almost the same as the value of B.

The amount C (mol) of anions that are doped into the conductive polymer included in the positive electrode may be a value obtained by subtracting, from an amount D (mol) of anions included in the electrolytic solution in a discharged state of the electrochemical device, an amount E (mol) of anions included in the electrolytic solution in a charged state of the electrochemical device.

Here, the “charged state” refers to a case where the SOC of the electrochemical device is 90% to 100%. The “discharged state” refers to a case where the SOC of the electrochemical device is 0% to 10%. The “SOC (state of charge)” refers to the percentage of the amount of charge relative to the capacitance at full charge.

The discharged state where the SOC is 0% to 10% is a state where the voltage of the electrochemical device is the end-of-discharge voltage. And the charged state where the SOC is 90% to 100% is a state where the voltage of the electrochemical device is the end-of-charge voltage. The end-of-discharge voltage and the end-of-charge voltage as well as charge and discharge conditions are determined by a manufacturer. In general, these conditions can be uniquely determined according to the charge/discharge circuit and product information provided by the manufacturer.

When a π-conjugated polymer is used as the conductive polymer and a carbon material is used as the negative electrode active material, the end-of-charge voltage is set to, for example, a voltage ranging from 3.4 V to 4.2 V, inclusive, and the end-of-discharge voltage is generally set to a voltage ranging from 2.5 V to 2.6 V, inclusive. When a π-conjugated polymer is used as the conductive polymer and lithium titanate is used as the negative electrode active material, the end-of-charge voltage is generally set to a voltage ranging from 2.4 V to 2.5 V, inclusive, and the end-of-discharge voltage is generally set to a voltage ranging from 1.1 V to 1.2 V, inclusive.

In order to improve the discharge characteristics, it is preferable that the conductive polymer have at least one anion accepting site per monomer unit that constitutes the conductive polymer. Here, the “anion accepting site” means a site at which the conductive polymer is theoretically capable of accepting (capable of being doped with) anions during charging from the viewpoint of the molecular structure of the conductive polymer. For example, polyaniline having aniline as a repeating monomer unit logically has one anion accepting site per aniline monomer unit.

The conductive polymer is desirably a π-conjugated polymer having a repeating unit including a heteroatom. Heteroatoms (such as a nitrogen atom and a sulfur atom) of a π-conjugated polymer tend to interact with anions. It is considered that anions are adsorbed onto or desorbed from heteroatoms during oxidation and reduction of the conductive polymer induced by charging and discharging.

Examples of the π-electron conjugated polymer include homopolymers and/or copolymers of at least one polymerizable compound selected from the group consisting of aniline, pyrrole, thiophene, furan, thiophene vinylene, pyridine, and derivatives thereof. That is, as the t-electron conjugated polymer, it is possible to use a homopolymer including a monomer unit derived from the polymerizable compound, or a copolymer including monomer units derived from two or more of the polymerizable compounds. More specifically, polyaniline, polypyrrole, polythiophene, polyfuran, polythiophene vinylene, polypyridine, a polymer derivative having a basic skeleton of these compounds, and the like are obtained. The polymer derivative is a polymer of a derivative compound such as an aniline derivative, a pyrrole derivative, a thiophene derivative, a furan derivative, a thiophene vinylene derivative, and a pyridine derivative. An example of the polymer derivative is poly(3,4-ethylenedioxythiophene) (PEDOT) having a basic skeleton of polythiophene. Among them, polyaniline, polypyrrole, polythiophene, or a polymer derivative having a basic skeleton of these compounds is preferable for the t-electron conjugated polymer because stable electrochemical characteristics (charge/discharge characteristics) can be obtained. Further, polyaniline is more preferable for the t-electron conjugated polymer since a high capacitance density is obtained.

The weight-average molecular weight of the conductive polymer is not particularly limited, but it ranges, for example, from 1000 to 100000, inclusive.

Examples of the anion with which the conductive polymer is to be doped and dedoped in association with charging and discharging include ClO₄⁻, BF₄⁻, PF₆⁻, AlCl₄⁻, SbF₆⁻, SCN⁻, CF₃SO₃⁻, FSO₃⁻, CF₃CO₂⁻, AsF₆⁻, B₁₀C₁₀⁻, Cl⁻, Br⁻, I⁻, BCl₄⁻, N(FSO₂)₂⁻, and N(CF₃SO₂)₂⁻. In particular, an oxoacid anion including a halogen atom, an imide anion and the like are desirable. The oxoacid anion including a halogen atom is preferably a tetrafluoroborate anion (BF₄⁻), a hexafluorophosphate anion (PF₆⁻), a perchlorate anion (ClO₄⁻), a fluorosulfate anion (FSO₃⁻) or the like. Among them, PF₆⁻ is more preferable since the conductive polymer is easily reversibly doped and dedoped with the anion. PF₆⁻ may account for 90 mol % or more of all the anions contained in the electrolytic solution in the charged state and the discharged state. The imide anion is preferably a bis(fluorosulfonyl)imide anion (N(FSO₂)₂⁻). These materials may be used alone or in combination of two or more thereof.

It is preferable to adjust the amount of anions in the electrolytic solution to be small so that the electrolytic solution contains almost no anions in the charged state (the SOC is 90% to 100%) (for example, the anion concentration in the electrolytic solution in the charged state is less than 0.5 mol/L). In this case, it is possible to reduce the proportion of the conductive polymer doped with anions in the positive electrode during charging. Therefore, even during long-term float charge, it is easy to reduce the proportion of the deteriorated conductive polymer, and to maintain better float characteristics.

In addition, when the electrochemical device is subjected to float charge in a state where the electrolytic solution has a high anion concentration, the conductive polymer tends to deteriorate easily. From this viewpoint too, it is preferable to adjust the amount of anions in the electrolytic solution so that the anion concentration in the electrolytic solution in the charged state is less than 0.5 mol/L. However, it is preferable to adjust the amount of anions in the electrolytic solution so that the anion concentration in the electrolytic solution in the charged state is 0.1 mol/L or more. This makes it possible to suppress the decrease in discharge capacitance of the electrochemical device.

Meanwhile, in the discharged state (the SOC is 0% to 10%), it is preferable to adjust the amount of anions in the electrolytic solution so that the anion concentration in the electrolytic solution ranges approximately from 1.0 mol/L to 2.5 mol/L, inclusive. In this case, anions doped into the conductive polymer during charging can be efficiently dedoped from the conductive polymer during discharging.

In the following, each constituent of the electrochemical device will be described in more detail.

### (Positive Electrode)

The positive electrode has, for example, a positive electrode material layer including, as a positive electrode active material, the above-mentioned conductive polymer. The positive electrode material layer is generally supported on a positive current collector. For the positive current collector, for example, a conductive sheet material is used. As the sheet material, metal foil, porous metal, perforated metal or the like is used. The material of the positive current collector may be aluminum, an aluminum alloy, nickel, titanium or the like.

The positive electrode material layer may further include, in addition to the positive electrode active material, a conductive agent and a binder. Examples of the conductive agent include carbon black and carbon fibers. Examples of the binder include a fluororesin, an acrylic resin, a rubber material, and a cellulose derivative.

The conductive polymer included in the positive electrode material layer is synthesized by polymerizing a polymerizable compound (monomer) that is a raw material of the conductive polymer. The synthesis of the conductive polymer may be carried out either by electrolytic polymerization or by chemical polymerization. For example, it is possible to form a film of the conductive polymer (positive electrode material layer) so as to cover at least part of a surface of the positive current collector by the following procedure. A conductive sheet material (for example, a metal foil piece) as the positive current collector is prepared. The positive current collector and a counter electrode in a monomer solution are immersed, and then an electric current between the positive current collector as an anode and the counter electrode is applied. The monomer solution may contain, as a dopant, anions exemplified above, or anions other than the anions exemplified above, such as a sulfate ion and a nitrate ion. It is also possible to add an oxidizing agent for promoting electrolytic polymerization.

### (Negative Electrode)

The negative electrode has, for example, a negative electrode material layer including a negative electrode active material. The negative electrode material layer is generally supported on a negative current collector. For the negative current collector, for example, a conductive sheet material is used. As the sheet material, metal foil, porous metal, perforated metal or the like is used. The material of the negative current collector may be copper, a copper alloy, nickel, stainless steel or the like.

Examples of the negative electrode active material include carbon materials, metal compounds, alloys, and ceramic materials. The carbon material is preferably graphite, hardly graphitizable carbon (hard carbon) or easily graphitizable carbon (soft carbon), particularly preferably graphite or hard carbon. Examples of the metal compound include silicon oxide and tin oxide. Examples of the alloy include silicon alloys and tin alloys. Examples of the ceramic material include lithium titanate and lithium manganate. These materials may be used alone or in combination of two or more thereof. In particular, the carbon material is preferable from the viewpoint that the material is capable of lowering the potential of the negative electrode.

The negative electrode material layer desirably includes, in addition to the negative electrode active material, a conductive agent, a binder and the like. For the conductive agent and the binder, those mentioned as examples for the positive electrode material layer can be used.

The negative electrode is desirably pre-doped with lithium ions in advance. Thus, the potential of the negative electrode is lowered, and the potential difference (that is, the voltage) between the positive electrode and the negative electrode increases, so that the energy density of the electrochemical device is improved.

Pre-doping of lithium ions into the negative electrode advances, for example, by the following manner. A metal lithium layer serving as a lithium ion supply source is formed on a surface of the negative electrode material layer. Lithium ions elute from the metal lithium layer into the electrolytic solution, and the eluted lithium ions are occluded in the negative electrode active material. For example, when graphite or hard carbon is used as the negative electrode active material, lithium ions are inserted between layers of graphite or into pores of hard carbon. The amount of lithium ions to be pre-doped can be controlled by the mass of the metal lithium layer.

The negative electrode material layer of the negative electrode is formed by preparing a negative electrode mixture paste that is a mixture of a negative electrode active material, a conductive agent, a binder and the like with a dispersion medium, and applying the negative electrode mixture paste to the negative current collector, for example.

The step of pre-doping lithium ions into the negative electrode may be performed before an electrode group is assembled, or the pre-doping may be advanced after an electrode group together with the electrolytic solution is put into a case of the electrochemical device.

### (Electrolytic Solution)

The electrolytic solution (nonaqueous electrolytic solution) contains a solvent (nonaqueous solvent) and a lithium salt soluble in a solvent. The lithium salt includes anions that are doped into the conductive polymer during charging, and lithium ions that are occluded in the negative electrode active material during charging.

Examples of the lithium salt include LiClO₄, LiBF₄, LiPF₆, LiAlCl₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(FSO₂)₂, and LiN(CF₃SO₂)₂. These lithium salts may be used alone or in combination of two or more thereof. In particular, it is desirable to use at least one lithium salt selected from the group consisting of lithium salts having an oxoacid anion including a halogen atom and lithium salts having an imide anion.

The concentration of the lithium salt in the electrolytic solution in the charged state (the SOC is 90% to 100%) is, for example, less than 0.5 mol/L.

Examples of the usable solvent include cyclic carbonates such as ethylene carbonate, propylene carbonate (PC), and butylene carbonate, chain carbonates such as dimethyl carbonate (DMC), diethyl carbonate, and ethyl methyl carbonate, aliphatic carboxylic acid esters such as methyl formate, methyl acetate, methyl propionate, and ethyl propionate, lactones such as γ-butyrolactone and γ-valerolactone, chain ethers such as 1,2-dimethoxyethane (DME), 1,2-diethoxyethane (DEE), and ethoxymethoxyethane (EME), cyclic ethers such as tetrahydrofuran and 2-methyltetrahydrofuran, dimethylsulfoxide, 1,3-dioxolane, formamide, acetamide, dimethylformamide, dioxolane, acetonitrile, propionitrile, nitromethane, ethyl monoglyme, trimethoxymethane, sulfolane, methylsulfolane, and 1,3-prop anesultone. These solvents may be used alone or in combination of two or more thereof. In particular, a mixed solvent containing DMC and PC is preferable from the viewpoint of ion conductivity. It is preferable that DMC and PC account for 50% by mass or more, more preferably 80% by mass or more of the solvent. In this case, the volume ratio between DMC and PC (DMC/PC) may range, for example, from 30/70 to 70/30, inclusive.

Additives may be added to the solvent in the electrolytic solution, if necessary. For example, an unsaturated carbonate such as vinylene carbonate, vinylethylene carbonate, or divinylethylene carbonate may be added as an additive for forming a film with high lithium ion conductivity on the negative electrode surface.

### (Separator)

It is preferable to interpose a separator between the positive electrode and the negative electrode. Examples of the usable separator include nonwoven fabrics made of cellulose fibers, nonwoven fabrics made of glass fibers, microporous films made of polyolefin, woven fabrics, and nonwoven fabrics. The thickness of the separator ranges, for example, from 10 μm to 300 μm, inclusive, preferably from 10 μm to 40 μm, inclusive.

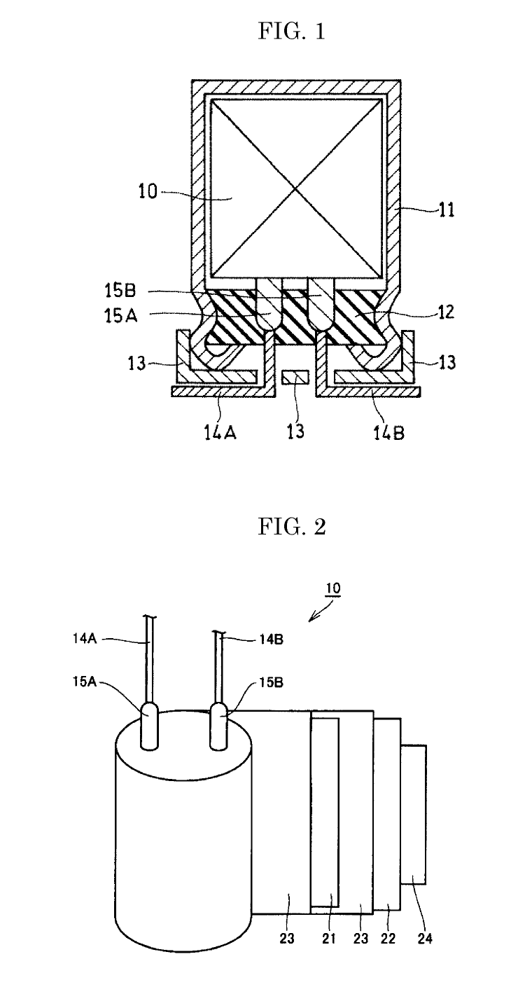

An electrochemical device according to an exemplary embodiment of the present disclosure will be described with reference to FIGS. 1 and 2.

Electrode group 10 is a wound body as shown in FIG. 2, and includes positive electrode 21, negative electrode 22, and separator 23 disposed between positive electrode 21 and negative electrode 22. The outermost periphery of the wound body is fixed by winding stop tape 24. Positive electrode 21 is connected to lead tab 15A, and negative electrode 22 is connected to lead tab 15B. The electrochemical device includes electrode group 10, bottomed case 11 that houses electrode group 10, sealing body 12 that closes an opening of bottomed case 11, lead wires 14A, 14B that are led out from sealing body 12, and electrolytic solution (not shown). Lead wires 14A, 14B are connected to lead tabs 15A, 15B, respectively. Sealing body 12 is formed of, for example, an elastic material including a rubber component. Bottomed case 11 is drawn to the inside at the vicinity of an opening end thereof, and the opening end is curled so as to be caulked with sealing body 12.

In the above-mentioned embodiment, a cylindrical electrochemical device including a wound electrode group has been described. However, it is also possible to form a rectangular electrochemical device including an electrode group that includes a laminate of a positive electrode and a negative electrode with a separator disposed between both the electrodes.

### EXAMPLES

Hereinafter, the present disclosure will be described in more detail with reference to examples, but the present disclosure is not limited to the examples.

### (1) Production of Positive Electrode

An aluminum foil piece having a thickness of 30 μm was prepared as a positive current collector. Meanwhile, an aniline aqueous solution containing aniline and sulfuric acid was prepared.

The positive current collector and a counter electrode were immersed in the aniline aqueous solution, and subjected to electrolytic polymerization at a current density of 10 mA/cm² for 20 minutes to deposit, onto entire front and back surfaces of the positive current collector, a film of a conductive polymer (polyaniline) doped with sulfate ions (SO₄²⁻) as a dopant for the conductive polymer.

The conductive polymer doped with sulfate ions was reduced to dedope the doped sulfate ions. In this way, a porous conductive polymer film (positive electrode material layer) from which sulfate ions had been dedoped was formed. The thickness of the conductive polymer film was 60 μm per one surface of the positive current collector. The conductive polymer film was thoroughly washed and then dried. Adjusting the dedoping amount of sulfate ions as a dopant for the conductive polymer enables adjustment of the amount of anions doped into and dedoped from the conductive polymer in association with charging and discharging, as well as adjustment of the amount of anions contained in the electrolytic solution during charging and discharging.

### (2) Production of Negative Electrode

A copper foil piece having a thickness of 20 μm was prepared as a negative current collector. Meanwhile, a carbon paste was prepared by kneading a mixed powder with water at a weight ratio of 40:60. The mixed powder includes 97 parts by mass of hard carbon, 1 part by mass of carboxycellulose, and 2 parts by mass of styrene butadiene rubber. The carbon paste was applied to both surfaces of the negative current collector and dried to produce a negative electrode having a negative electrode material layer having a thickness of 35 μm on each surface. Then, a metal lithium layer in an amount calculated so that the negative electrode potential in the electrolytic solution after completion of the pre-doping was less than or equal to 0.2 V with respect to metal lithium was formed on the negative electrode material layer.

### (3) Production of Electrode Group

A lead tab was connected to each of the positive electrode and the negative electrode. Then, as shown in FIG. 2, a laminate obtained by alternately laminating cellulose nonwoven fabric separators (each having a thickness of 35 μm) with a positive electrode and a negative electrode was wound up to form an electrode group.

### (4) Preparation of Electrolytic Solution

To a mixture of propylene carbonate and dimethyl carbonate in a volume ratio of 1:1, 0.2% by mass of vinylene carbonate was added to prepare a solvent. LiPF₆ as a lithium salt was dissolved in the obtained solvent at a predetermined concentration to prepare an electrolytic solution containing hexafluorophosphate ions (PF₆⁻) as anions.

### (5) Production of Electrochemical Device

The electrode group and the electrolytic solution were put into a bottomed case having an opening to assemble an electrochemical device as shown in FIG. 1. Then, the electrochemical device was aged at 25° C. for 24 hours while a charging voltage of 3.8 V was applied between terminals of the positive electrode and the negative electrode to advance the pre-doping of the lithium ions into the negative electrode.

In the production of the electrochemical device, the amount of electrolytic solution included in the case was kept constant while the lithium salt concentration in the electrolytic solution included in the case was varied to produce test cells Nos. 1 to 12 each having a B/A value shown in Table 1. Note that in Table 1, Nos. 1 to 6 are examples, and Nos. 7 to 12 are comparative examples.

TABLE 1

| | | Capacitance |
|---|---|---|
| Cell No. | B/A | retention rate (%) |
| 1 | 0.50 | 99.7 |
| 2 | 0.54 | 101.7 |
| 3 | 0.60 | 99.8 |
| 4 | 0.63 | 97.3 |
| 5 | 0.67 | 97.4 |
| 6 | 0.68 | 100.0 |
| 7 | 0.73 | 92.0 |
| 8 | 0.76 | 85.1 |
| 9 | 0.78 | 77.4 |
| 10 | 0.84 | 70.6 |
| 11 | 1.01 | 56.5 |
| 12 | 1.04 | 55.0 |

### [Evaluation]

### (1) Measurement of Capacitance Retention Rate (Evaluation of Float Characteristics)

The electrochemical devices obtained as described above were subjected to a charge/discharge test in the order of charge, pause, and discharge under the following conditions, and the initial discharge capacitance A (capacitance per 1 g of the positive electrode active material) was measured.

Ambient temperature: 25° C.

Charge: 1 C charge at a constant current until the voltage reaches an end-of-charge voltage of 3.8 V

Pause: 5 minutes

Discharge: 1 C discharge at a constant current until the voltage reaches an end-of-discharge voltage of 2.5 V

“1 C charge” means constant current charge with a quantity of electricity corresponding to the rated capacitance C (unit: mAh) of the electrochemical device in 1 hour. “1 C discharge” means constant current discharge with a quantity of electricity corresponding to the rated capacitance C of the electrochemical device in 1 hour.

Separately, an electrochemical device obtained as described above was prepared. The electrochemical device was charged under the same conditions as the above-mentioned charge conditions, and further charged at a constant voltage of 3.8 V for 1000 hours (float charge). Then, the electrochemical device was discharged under the same conditions as the above-mentioned discharge conditions, and the discharge capacitance B was measured.

Using the discharge capacities A and B obtained as described above, the capacitance retention rate was obtained from the following formula, and the float characteristics were evaluated.

Capacitance retention rate (%)=(discharge capacitance B/discharge capacitance A)×100

### (2) Measurement of A and B

(i) Total Amount a (Mol) of Monomer Units that Constitute Conductive Polymer

### Included in Positive Electrode

The electrochemical device was disassembled and the positive electrode was taken out, and the positive electrode material layer was peeled from the positive current collector. Then, the total number of moles of nitrogen atoms in polyaniline included in the positive electrode material layer was determined by ICP emission spectroscopic analysis. Based on the fact that one monomer unit (aniline skeleton) includes one nitrogen atom, the total amount A (mol) of monomer units that constitute the conductive polymer in the positive electrode material layer was determined. Polyaniline logically has one anion accepting site per monomer unit (aniline skeleton).

### (ii) Total Amount B (Mol) of Anions Included in Electrochemical Device

The total amount B (mol) of anions (PF₆⁻) included in the electrochemical device was determined by adding the amount (mol) of anions included in the positive electrode and the amount (mol) of anions contained in the electrolytic solution.

The amount of anions (PF₆⁻) included in the positive electrode was determined by the following procedure. That is, the electrochemical device was disassembled, the positive electrode was taken out, and then the positive electrode material layer was peeled from the positive current collector. Then, the positive electrode material layer was dissolved by heating in a mixed acid (a mixture of hydrochloric acid, nitric acid, and water) and allowed to cool. The insoluble matter was removed by filtration, the solution was adjusted to a desired volume, and the P (phosphorus) concentration was measured by ICP emission spectroscopic analysis.

The amount of anions (PF₆⁻) contained in the electrolytic solution was obtained by using the amount of the electrolytic solution included in the electrochemical device and the anion concentration (PF₆⁻) in the electrolytic solution.

The amount of the electrolytic solution included in the electrochemical device was determined by the following procedure. That is, the electrochemical device was disassembled, the electrode group including the electrolytic solution was taken out, and the weight W1 of the electrode group before being dried was measured. Then, the electrode group was disassembled, the positive electrode, the negative electrode, and the separator were individually washed with water and then dried, and the total weight W2 of the positive electrode, the negative electrode, and the separator after being dried was measured. Then, W2 was subtracted from W1 to determine the amount of the electrolytic solution.

The anion concentration in the electrolytic solution included in the electrochemical device was determined by disassembling the electrochemical device, collecting the electrolytic solution included in the separator, and measuring the P (phosphorus) concentration by ICP emission spectroscopic analysis.

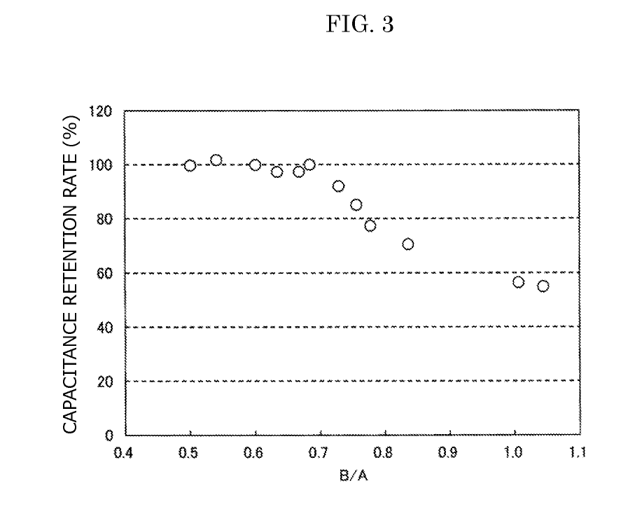

As shown in Table 1 and FIG. 3, in the test cells (Nos. 1 to 6) each having a B/A ratio less than 0.7, all of which were test cells of examples of the present disclosure, the capacitance retention rate was high, and a decrease in capacitance after the float charge was suppressed. In the test cells (Nos. 7 to 12) each having a B/A ratio of 0.7 or more, all of which were test cells of comparative examples, the capacitance retention rate was low.

### INDUSTRIAL APPLICABILITY

The electrochemical device according to the present disclosure has higher capacitance than electric double layer capacitors and lithium ion capacitors do, and can be suitably applied to uses in which higher power is required than in lithium ion secondary batteries.

### REFERENCE MARKS IN THE DRAWINGS

10 electrode group
11 bottomed case
12 sealing body
14A, 14B lead wire
15A, 15B lead tab
21 positive electrode
22 negative electrode
23 separator
24 winding stop tape

1. An electrochemical device comprising:
a positive electrode including, as a positive electrode active material, a conductive polymer that is to be doped and dedoped with anions;
a negative electrode including a negative electrode active material that occludes and releases lithium ions; and
an electrolytic solution containing the anions and the lithium ions,
wherein 0<B/A<0.7 is satisfied,
where A represents a total amount (mol) of monomer units that constitute the conductive polymer included in the positive electrode and B represents a total amount (mol) of the anions included in the electrochemical device.

2. The electrochemical device according to claim 1, wherein the conductive polymer includes at least one selected from the group consisting of polyaniline, polypyrrole, polythiophene, and a polymer derivative having a basic skeleton of polyaniline, polypyrrole, polythiophene.

3. The electrochemical device according to claim 1, wherein the anions include at least one selected from the group consisting of BF₄⁻, PF₆⁻, ClO₄⁻, FSO₃⁻, and N(FSO₂)₂⁻.

4. The electrochemical device according to claim 1, wherein the electrolytic solution contains dimethyl carbonate and propylene carbonate as solvents.
